(19) United States
(12) Patent Application Publication
(10) Pub. No.: US 2024/0337897 A1
(43) Pub. Date: Oct. 10, 2024

(54) OPTICAL PULSE ADJUSTING DEVICE, METHOD OF OPERATION THEREOF, AND SUPERCONTINUUM GENERATING DEVICE INCLUDING THEREOF

(71) Applicant: ELECTRONICS AND TELECOMMUNICATIONS RESEARCH INSTITUTE, Daejeon (KR)

(72) Inventors: Joon Tae AHN, Daejeon (KR); Minje SONG, Daejeon (KR); Minhyup SONG, Daejeon (KR); Taehyun LEE, Daejeon (KR); Seungyoung LIM, Daejeon (KR); Young Jin JUNG, Daejeon (KR); Gyu Dong CHOI, Daejeon (KR)

(73) Assignee: ELECTRONICS AND TELECOMMUNICATIONS RESEARCH INSTITUTE, Daejeon (KR)

(21) Appl. No.: 18/624,945

(22) Filed: Apr. 2, 2024

(30) Foreign Application Priority Data
Apr. 4, 2023 (KR) 10-2023-0044094

(51) Int. Cl. G02F 1/35; H01S 3/00

(52) U.S. Cl. CPC G02F 1/353; H01S 3/0057; H01S 3/0085; G02F 2203/56

(57) ABSTRACT

Disclosed is an optical pulse adjusting device including a pulse shaper that receives an input signal generated based on an optical frequency comb (OFC) signal and outputs a spectrum adjustment signal by adjusting an optical spectrum shape of the input signal, an optical amplifier that outputs an optical amplification signal by amplifying the spectrum adjustment signal, an optical spectrum analyzer (OSA) that outputs an information signal by comparing an optical spectrum shape of the optical amplification signal with a target optical spectrum shape, and a control circuit that outputs a comparison signal based on the information signal. The pulse shaper further receives the comparison signal and adjusts the optical spectrum shape of the input signal based on information about a difference between the optical spectrum shape of the optical amplification signal and the target optical spectrum shape, which is included in the comparison signal.

### CROSS-REFERENCE TO RELATED APPLICATIONS

This application claims priority under 35 U.S.C. § 119 to Korean Patent Application No. 10-2023-0044094 filed on Apr. 4, 2023, in the Korean Intellectual Property Office, the disclosures of which are incorporated by reference herein in their entireties.

### BACKGROUND

Embodiments of the present disclosure described herein relate to a supercontinuum generating device and more particularly, relate to an optical pulse adjusting device, a method of operating the same, and a supercontinuum generating device including the same.

The proliferation of high-performance computers, smart devices, and multimedia has created a demand for high-speed data processing technologies in wired and wireless communications. Furthermore, there is a growing need for the development of miniaturized (integrated) and low-cost communication modules with these technologies.

Optical communication is a type of communication that transmits and receives data signals in light. The optical communication may be achieved by converting an electrical signal including transmission information into an optical signal and transmitting the optical signal, and converting the received optical signal into an electrical signal. Compared to radio wave communication, the optical communication has a wide bandwidth and performs high-speed communication.

A supercontinuum is an optical frequency comb (OFC) with a constant frequency interval and is used for optical communication. The bandwidth of an OFC signal may be expanded for optical communication. In this case, the wavelength-dependent intensity variation may be great within the bandwidth of the OFC signal. Accordingly, the flatness of the OFC signal may be poor. As a result, there is a need for a supercontinuum generating device with improved flatness.

### SUMMARY

Embodiments of the present disclosure provide a supercontinuum generating device that generates a supercontinuum signal with improved flatness by using a pulse shaper.

According to an embodiment, an optical pulse adjusting device includes a pulse shaper that receives an input signal generated based on an optical frequency comb (OFC) signal and outputs a spectrum adjustment signal by adjusting an optical spectrum shape of the input signal, an optical amplifier that outputs an optical amplification signal by amplifying the spectrum adjustment signal, an optical spectrum analyzer (OSA) that outputs an information signal by comparing an optical spectrum shape of the optical amplification signal with a target optical spectrum shape, and a control circuit that outputs a comparison signal based on the information signal. The pulse shaper further receives the comparison signal and adjusts the optical spectrum shape of the input signal based on a difference between the optical spectrum shape of the optical amplification signal and the target optical spectrum shape, which is included in the comparison signal.

In an embodiment, the pulse shaper is configured to adjust the optical spectrum shape of the input signal by adjusting an optical loss for each of wavelength components of the input signal based on the comparison signal.

In an embodiment, the optical pulse adjusting device further includes an optical coupler that branches the optical amplification signal and inputs the branched optical amplification signal to the OSA.

In an embodiment, the target optical spectrum shape is a Gaussian distribution shape.

In an embodiment, the OFC signal is a signal generated based on an electro-optic (EO) modulation method.

In an embodiment, the optical amplifier is a high power amplifier (HPA).

According to an embodiment, a supercontinuum signal generating device includes an OFC signal generating unit that outputs an OFC signal, and an OFC expansion unit that generates a supercontinuum signal by adjusting flatness of the OFC signal. The OFC expansion unit includes a first non-linear stage including a first optical amplifier and outputting an amplification signal based on the OFC signal, an optical pulse adjusting device that outputs a pulse shaping signal based on the amplification signal, and a second non-linear stage that generates the supercontinuum signal based on the pulse shaping signal. The optical pulse adjusting device includes a pulse shaper that outputs a spectrum adjustment signal by adjusting an optical spectrum shape of the amplification signal, a second optical amplifier that outputs an optical amplification signal by amplifying the spectrum adjustment signal, an OSA that outputs an information signal by comparing the optical spectrum shape of the optical amplification signal with a target optical spectrum shape, and a comparison device that outputs a comparison signal based on the information signal. The pulse shaper further receives the comparison signal and adjusts the optical spectrum shape of the amplification signal based on information about a difference between the optical spectrum shape of the optical amplification signal and the target optical spectrum shape, which is included in the comparison signal. The pulse shaping signal is the optical amplification signal when the optical spectrum shape of the optical amplification signal is the target optical spectrum shape.

In an embodiment, the pulse shaper is configured to adjust the optical spectrum shape of the amplification signal by adjusting an optical loss for each of wavelength components of the amplification signal based on the comparison signal.

In an embodiment, the target optical spectrum shape is a Gaussian distribution shape.

In an embodiment, the OFC signal generating unit is configured to generate the OFC signal in an EO modulation method.

In an embodiment, the OFC signal generating unit is configured to generate the OFC signal based on a resonator.

In an embodiment, the optical pulse adjusting device further includes an optical coupler that branches the optical amplification signal and inputs the branched optical amplification signal to the OSA.

In an embodiment, the first non-linear stage further includes a first optical fiber connected to an output terminal of the first optical amplifier, and a second optical fiber connected to the first optical fiber. The first optical amplifier, the first optical fiber, and the second optical fiber are configured to generate the amplification signal by expanding a bandwidth of the OFC signal.

In an embodiment, the second non-linear stage includes a third optical fiber, and the third optical fiber is configured to generate the supercontinuum signal by expanding a bandwidth of the pulse shaping signal.

In an embodiment, the first optical fiber is a single mode fiber (SMF).

In an embodiment, each of the second optical fiber and the third optical fiber a highly non-linear fiber (HNLF).

In an embodiment, the first optical amplifier is an erbium-doped fiber amplifier (EDFA), and the second optical amplifier is a high power amplifier (HPA).

According to an embodiment, an operating method of an optical pulse adjusting device outputting a pulse shaping signal includes receiving an input signal generated based on a frequency comb signal, generating a spectrum adjustment signal by adjusting an optical loss for each of wavelength components of the input signal, amplifying the spectrum adjustment signal and generating an optical amplification signal by expanding a bandwidth of the spectrum adjustment signal, comparing an optical spectrum shape of the optical amplification signal with a target optical spectrum shape, and outputting the pulse shaping signal based on the comparison result.

In an embodiment, the outputting of the pulse shaping signal further includes outputting the optical amplification signal as the pulse adjustment signal, when the optical spectrum shape of the optical amplification signal is the same as the target optical spectrum shape.

In an embodiment, the target optical spectrum shape is a Gaussian distribution shape.

### BRIEF DESCRIPTION OF THE FIGURES

The above and other objects and features of the present disclosure will become apparent by describing in detail embodiments thereof with reference to the accompanying drawings.

FIG. 1 is a block diagram for describing a supercontinuum generating device, according to an embodiment of the present disclosure.

FIG. 2 is a block diagram for describing the OFC signal generating unit of FIG. 1.

FIG. 3 is a block diagram for describing the OFC expansion unit of FIG. 1.

FIG. 4 is a diagram for describing the first non-linear stage of FIG. 3.

FIG. 5 is a block diagram illustrating an example of the optical pulse adjusting device of FIG. 3.

FIG. 6 is a diagram for describing an example of the second non-linear stage of FIG. 3.

FIG. 7 is a block diagram for describing the optical pulse adjusting device of FIG. 3.

FIG. 8 is a diagram for describing the second non-linear stage of FIG. 3.

FIG. 9 is a flowchart illustrating an operating method of an optical pulse adjusting device, according to an embodiment of the present disclosure.

### DETAILED DESCRIPTION

Hereinafter, embodiments of the present disclosure will be described in detail and clearly to such an extent that an ordinary one in the art easily implements the present disclosure. In the description below, the terms “block”, “unit”, “module”, etc. or components corresponding to the terms may be implemented in the form of software, hardware, or a combination thereof.

In the following drawings or in the detailed description, modules may be connected with any other components except for components illustrated in a drawing or described in the detailed description. Modules or components may be connected directly or indirectly. Modules or components may be connected through communication or may be physically connected.

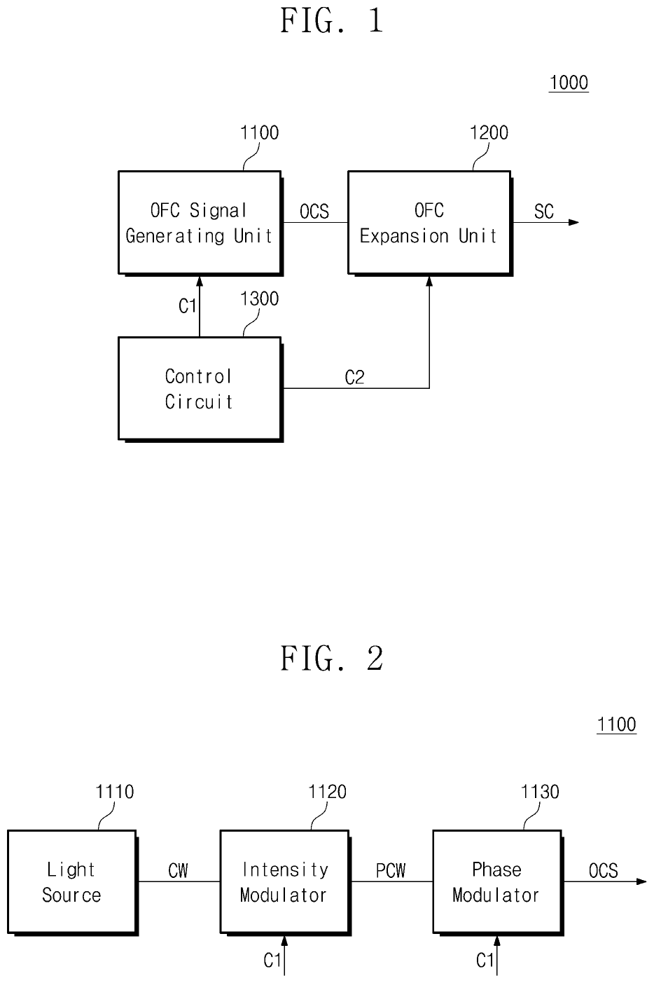

FIG. 1 is a block diagram for describing a supercontinuum generating device, according to an embodiment of the present disclosure. Referring to FIG. 1, a supercontinuum generating device 1000 may include an OFC signal generating unit 1100, an OFC expansion unit 1200, and a control circuit 1300. The supercontinuum generating device 1000 may output a supercontinuum signal SC. The supercontinuum signal SC may be an OFC signal with a constant frequency interval.

The OFC signal generating unit 1100 may output an OFC signal OCS. In an embodiment, the OFC signal generating unit 1100 may generate the OFC signal OCS by using an electro-optic (EO) modulator. Accordingly, the OFC signal generating unit 1100 may continuously change the frequency comb interval of the OFC signal OCS. For example, the bandwidth of the OFC signal OCS may be between a few nanometers (nm) and tens of nanometers. The OFC signal OCS may have a large change in intensity depending on the wavelength within a bandwidth. Accordingly, the flatness of the OFC signal OCS may be poor.

In an embodiment, the OFC signal generating unit 1100 may generate the OFC signal OCS based on a resonator. For example, the OFC signal generating unit 1100 may generate the OFC signal OCS by using a mode-locked laser. For example, the OFC signal generating unit 1100 may generate the OFC signal OCS by using a micro-resonator.

The OFC expansion unit 1200 may be connected to the OFC signal generating unit 1100. The OFC expansion unit 1200 may receive the OFC signal OCS. The OFC expansion unit 1200 may generate the supercontinuum signal SC based on the OFC signal OCS. The OFC expansion unit 1200 may adjust an optical loss for each wavelength component of the OFC signal OCS. Accordingly, the OFC expansion unit 1200 may output the supercontinuum signal SC with improved flatness. For example, the bandwidth of the supercontinuum signal SC may be greater than or equal to hundred nanometers.

The control circuit 1300 may output control signals C1 and C2 for controlling the OFC signal generating unit 1100 and the OFC expansion unit 1200.

FIG. 2 is a block diagram for describing the OFC signal generating unit of FIG. 1. Referring to FIG. 2, the OFC signal generating unit 1100 may include a light source 1110, an intensity modulator 1120, and a phase modulator 1130.

The light source 1110 may output an optical signal CW. The light source 1110 may output the optical signal CW with a single wavelength. The light source 1110 may continuously output the optical signal CW of a specific magnitude. For example, the light source 1110 may be a continuous wave laser.

The intensity modulator 1120 may receive the optical signal CW. The intensity modulator 1120 may modulate the intensity of the optical signal CW received from the light source 1110. For example, the intensity modulator 1120 may modulate the optical signal CW, which has a constant output, into a sinusoidal wave. The intensity modulator 1120 may perform intensity modulation of the optical signal CW based on the first control signal C1. The intensity modulator 1120 may output an intensity modulation signal PCW by modulating the intensity of the optical signal CW.

The phase modulator 1130 may receive the intensity modulation signal PCW. The phase modulator 1130 may modulate the phase of the intensity modulation signal PCW based on the first control signal C1. The phase modulator 1130 may modulate the intensity modulation signal PCW so as to have a flat-top optical spectrum through phase modulation. For example, the phase modulator 1130 may expand the optical spectrum of the intensity modulation signal PCW by replicating the optical frequency by a modulation frequency interval of the first control signal C1. The phase modulator 1130 may output the OFC signal OCS by modulating the phase of the intensity modulation signal PCW.

In an embodiment, the first control signal C1 may include information about an RF frequency applied to an intensity modulator and information about the RF frequency applied to a phase modulator. For example, the frequency comb interval of the OFC signal OCS may be determined based on information about the RF frequency included in the first control signal C1.

For example, the intensity modulator 1120 and the phase modulator 1130 may be little affected by surrounding environments. Accordingly, the frequency stability of the OFC signal OCS may be excellent.

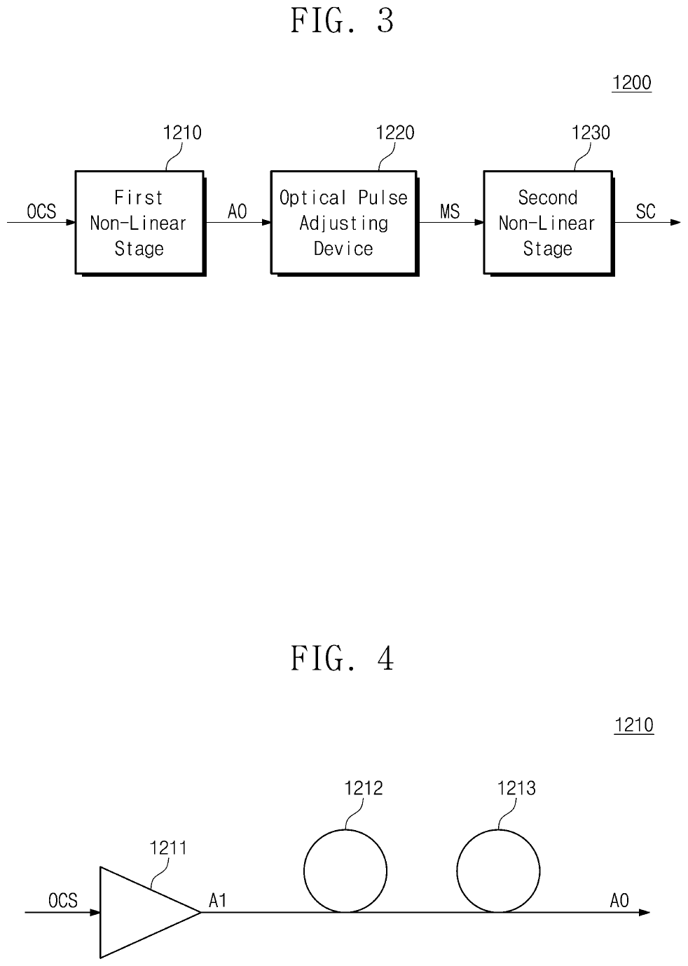

FIG. 3 is a block diagram for describing the OFC expansion unit of FIG. 1. Referring to FIG. 3, the OFC expansion unit 1200 may include a first non-linear stage 1210, an optical pulse adjusting device 1220, and a second non-linear stage 1230.

The first non-linear stage 1210 may receive the OFC signal OCS. The first non-linear stage 1210 may expand the bandwidth of the OFC signal OCS. The first non-linear stage 1210 may expand the bandwidth of the OFC signal OCS and may output the amplification signal AO.

The optical pulse adjusting device 1220 may receive the amplification signal AO. The optical pulse adjusting device 1220 may compare an optical spectrum shape of the amplification signal AO with the optical spectrum shape of a target signal. The optical pulse adjusting device 1220 may adjust the optical spectrum shape of the amplification signal AO based on the comparison result. The optical pulse adjusting device 1220 may output a pulse shaping signal MS by adjusting the optical spectrum shape of the amplification signal AO. The optical spectrum shape of the pulse shaping signal MS may be in a form of a Gaussian distribution shape.

The second non-linear stage 1230 may receive the pulse shaping signal MS. The second non-linear stage 1230 may output the supercontinuum signal SC by expanding the bandwidth of the pulse shaping signal MS.

FIG. 4 is a diagram for describing the first non-linear stage of FIG. 3. Referring to FIG. 4, the first non-linear stage 1210 may include a first optical amplifier 1211, a first optical fiber 1212, and a second optical fiber 1213.

The OFC signal OCS may be input to the first optical amplifier 1211. The first optical amplifier 1211 may amplify the OFC signal OCS. The first optical amplifier 1211 may amplify the OFC signal OCS and then may output an input amplification signal A1. In an embodiment, the first optical amplifier may be an erbium-doped fiber amplifier (EDFA).

The first optical fiber 1212 and the second optical fiber 1213 may expand the bandwidth of the input amplification signal A1. In an embodiment, the first optical fiber 1212 may be a single mode fiber (SMF), and the second optical fiber 1213 may be a highly non-linear fiber (HNLF). In this case, the first optical fiber 1212 may expand a bandwidth of the input amplification signal Al through dispersion compensation by length adjustment. Moreover, the second optical fiber 1213 may expand the bandwidth of a signal passing through the first optical fiber 1212 through non-linear phenomena such as four wave mixing. Accordingly, the second optical fiber 1213 may output the amplification signal AO.

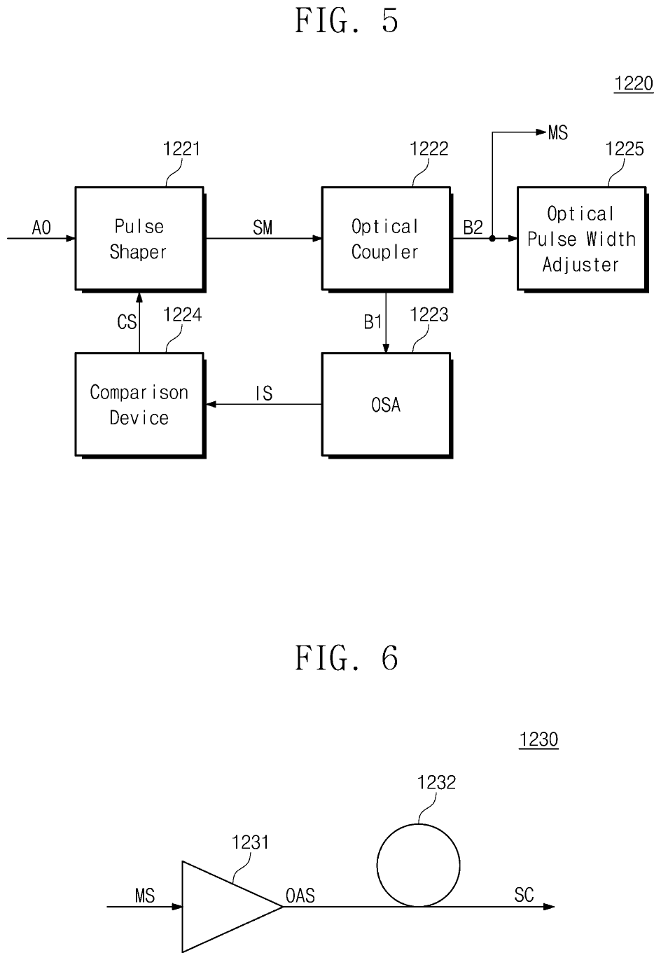

FIG. 5 is a block diagram illustrating an example of the optical pulse adjusting device of FIG. 3. The optical pulse adjusting device 1220 may include a pulse shaper 1221, an optical coupler 1222, an optical spectrum analyzer (OSA) 1223, a comparison device 1224, and an optical pulse width adjuster 1225. The components of the optical pulse adjusting device 1220 may operate based on the second control signal C2.

The pulse shaper 1221 may adjust the amplification signal AO based on a comparison signal CS. The pulse shaper 1221 may output a spectrum adjustment signal SM by adjusting the optical spectrum shape of the amplification signal AO. The pulse shaper 1221 may adjust light loss for each of wavelength components of the amplification signal AO. The pulse shaper 1221 may adjust the amplification signal AO based on the comparison signal CS until the optical spectrum shape of the spectrum adjustment signal SM becomes the desired shape. Accordingly, the pulse shaper 1221 may output the spectrum adjustment signal SM having a target optical spectrum shape.

The optical coupler 1222 may receive the spectrum adjustment signal SM. The optical coupler 1222 may branch the spectrum adjustment signal SM and may output a first branch signal B1 and a second branch signal B2. The first branch signal B1 may be input to the OSA 1223. The second branch signal B2 may be input to the optical pulse width adjuster 1225. At this time, the first branch signal B1 may include information about the optical spectrum shape of the spectrum adjustment signal SM, and the second branch signal B2 may include information about the optical pulse width of the spectrum adjustment signal SM. When the optical spectrum shape of the spectrum adjustment signal SM is the same as the target optical spectrum shape, the optical coupler 1222 may output the spectrum adjustment signal SM to the outside as the pulse shaping signal MS.

The OSA 1223 may compare the optical spectrum shape of the spectrum adjustment signal SM with the target optical spectrum shape based on the first branch signal B1. At this time, the target optical spectrum shape may be a Gaussian shape. The OSA 1223 may output information signal IS. The information signal IS may include information about the comparison result.

The comparison device 1224 may output the comparison signal CS based on the information signal IS. The comparison signal CS may include information about how the pulse shaper 1221 needs to adjust an optical loss for each wavelength of the amplification signal AO. In other words, the comparison signal CS may include information about a difference between the optical spectrum shape of the spectrum adjustment signal SM and the target optical spectrum shape.

In an embodiment, the comparison device 1224 may be a computer. For example, the computer may refer to any type of hardware device including at least one processor. Moreover, according to an embodiment, the computer may also include software configurations operating on the corresponding hardware device. For example, the computer may include smartphones, tablet PCs, desktops, laptops, and user clients and applications, which are running on each device. However, the present disclosure is not limited thereto.

When the current optical spectrum shape of the spectrum adjustment signal SM has a target optical spectrum shape, the optical pulse adjusting device 1220 may output the current spectrum adjustment signal SM to the outside through the optical coupler 1222. In other words, the pulse shaping signal MS output by the optical pulse adjusting device 1220 may be the current spectrum adjustment signal SM.

For example, at a first time point, the pulse shaper 1221 may output the spectrum adjustment signal SM by adjusting the amplification signal AO. The OSA 1223 may output the information signal IS by comparing the optical spectrum shape of the spectrum adjustment signal SM with the optical spectrum shape of the target optical signal. The comparison device 1224 may output the comparison signal CS based on the information signal. Afterward, at a second time point, the pulse shaper 1221 may again output the spectrum adjustment signal SM based on the comparison signal CS described above. At this time, the optical spectrum shape of the spectrum adjustment signal SM may be the same as the target optical spectrum shape. In this case, the optical pulse adjusting device 1220 may output the spectrum adjustment signal SM generated after the second time point to the outside through the optical coupler 1222. In other words, the pulse shaping signal MS may be the spectrum adjustment signal SM generated after the second time point.

FIG. 6 is a diagram for describing an example of the second non-linear stage of FIG. 3. FIG. 6 is described with reference to FIG. 5. Referring to FIG. 6, the second non-linear stage 1230 may include a second optical amplifier 1231 and a third optical fiber 1232. The pulse shaping signal MS may be input to the second optical amplifier 1231.

The second optical amplifier 1231 may amplify the pulse shaping signal MS and then may output an optical amplification signal OAS. For example, the second optical amplifier 1231 may be a high power amplifier (HPA).

The optical amplification signal OAS may be input to the third optical fiber 1232. The third optical fiber 1232 may output the supercontinuum signal SC by expanding the bandwidth of the optical amplification signal OAS. In an embodiment, the third optical fiber 1232 may be a HNLF. The third optical fiber 1232 may expand the bandwidth of the optical amplification signal OAS through self-phase modulation.

As the pulse shaping signal MS is amplified by the second optical amplifier 1231, the optical amplification signal OAS may include a signal obtained by adding non-linear phenomenon, dispersion, and optical noise to the pulse shaping signal MS. Accordingly, the optical spectrum shape of the pulse shaping signal MS adjusted to have a target optical spectrum shape may be distorted as the pulse shaping signal MS passes through the second optical amplifier 1231. Accordingly, the flatness characteristics of the supercontinuum signal SC generated by the second non-linear stage 1230 may be deteriorated. Therefore, the OFC expansion unit 1200 capable of minimizing optical spectrum distortion factors added during an optical amplification process by the second optical amplifier 1231 may be required.

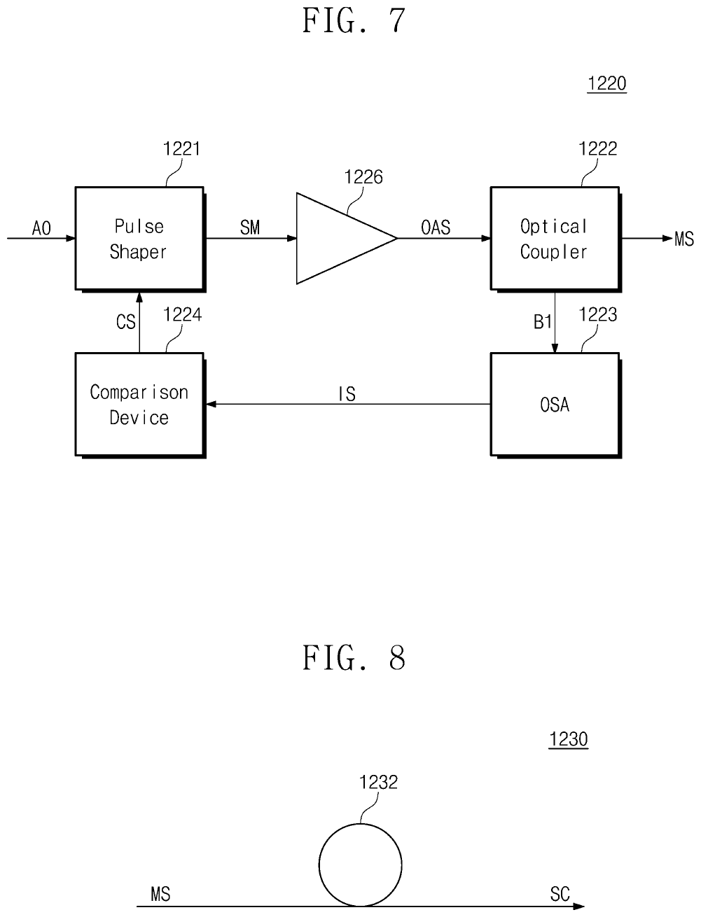

FIG. 7 is a block diagram for describing the optical pulse adjusting device of FIG. 3, according to an embodiment of the present disclosure. The first non-linear stage 1210 included in the OFC expansion unit 1200 according to an embodiment of the present disclosure is as described in FIG. 4. Referring to FIG. 7, the optical pulse adjusting device 1220 according to an embodiment of the present disclosure may include the pulse shaper 1221, the optical coupler 1222, the OSA 1223, the comparison device 1224, and a second optical amplifier 1226. Unlike the case of FIG. 5, the optical pulse adjusting device 1220 according to an embodiment of the present disclosure may include the second optical amplifier 1226. Each of the components of the optical pulse adjusting device 1220 may operate based on the second control signal C2.

The pulse shaper 1221 may adjust the amplification signal AO based on a comparison signal CS. The pulse shaper 1221 may output a spectrum adjustment signal SM by adjusting the optical spectrum shape of the amplification signal AO. The pulse shaper 1221 may adjust light loss for each of wavelength components of the amplification signal AO. Accordingly, the pulse shaper 1221 may adjust the amplification signal AO such that the pulse shaping signal MS has a target optical spectrum shape.

The spectrum adjustment signal SM may be input to the second optical amplifier 1226. The second optical amplifier 1226 may amplify the spectrum adjustment signal SM and then may output the optical amplification signal OAS. In an embodiment, the second optical amplifier 1226 may be an HPA.

The optical coupler 1222 may receive the optical amplification signal OAS. The optical coupler 1222 may branch the optical amplification signal OAS and then may output the first branch signal B1. The first branch signal B1 may be input to the OSA 1223. The first branch signal B1 may include information about the optical spectrum shape of the optical amplification signal OAS. When the optical spectrum shape of the optical amplification signal OAS is the same as the target optical spectrum shape, the optical coupler 1222 may output the optical amplification signal OAS to the outside as the pulse shaping signal MS. The OSA 1223 may compare the optical spectrum shape of the optical amplification signal OAS with the target optical spectrum shape based on the first branch signal B1. The target optical spectrum shape may be a Gaussian distribution shape. The OSA 1223 may output the information signal IS including information about the comparison result.

The comparison device 1224 may receive the information signal IS. The comparison device 1224 may output the comparison signal CS based on the information signal IS. The comparison signal CS may include information about how the pulse shaper 1221 needs to adjust an optical loss for each wavelength of the amplification signal AO. In other words, the comparison signal CS may include information about a difference between the optical spectrum shape of the optical amplification signal OAS and the target optical spectrum shape.

In an embodiment, the comparison device 1224 may be a computer. For example, the computer may refer to any type of hardware device including at least one processor. Moreover, according to an embodiment, the computer may also include software configurations operating on the corresponding hardware device. For example, the computer may include smartphones, tablet PCs, desktops, laptops, and user clients and applications, which are running on each device. However, the present disclosure is not limited thereto.

When the current optical spectrum shape of the optical amplification signal OAS has a target optical spectrum shape, the optical pulse adjusting device 1220 may output the current optical amplification signal OAS to the outside through the optical coupler 1222. In other words, the pulse shaping signal MS output by the optical pulse adjusting device 1220 may be the current optical amplification signal OAS. In this case, the optical spectrum shape of the pulse shaping signal MS may be in a form of a Gaussian distribution shape. Accordingly, the flatness characteristics of the supercontinuum signal SC may be improved.

For example, at a first time point, the pulse shaper 1221 may output the spectrum adjustment signal SM by adjusting the amplification signal AO. Afterward, the second optical amplifier 1226 may amplify the pulse shaping signal MS and then may output an optical amplification signal OAS. At this time, the optical spectrum shape of the optical amplification signal OAS may be different from the target optical spectrum shape. In this case, the comparison device 1224 may output the comparison signal CS based on the information signal IS.

At a second time point after the first time point, the pulse shaper 1221 may again output the spectrum adjustment signal SM based on the comparison signal CS described above. Afterward, the second optical amplifier 1226 may amplify the pulse shaping signal MS and then may output an optical amplification signal OAS. At this time, the optical spectrum shape of the optical amplification signal OAS may be the same as the target optical spectrum shape. In this case, the optical pulse adjusting device 1220 may output the optical amplification signal OAS through the optical coupler 1222. In other words, the pulse shaping signal MS may be the optical amplification signal OAS generated after the above-described second time point.

FIG. 8 is a diagram for describing the second non-linear stage of FIG. 3. Referring to FIG. 8, the second non-linear stage 1230 according to an embodiment of the present disclosure may include the third optical fiber 1232. Referring to FIG. 8, unlike the case of FIG. 6, the second non-linear stage 1230 of the supercontinuum generating device 1000 according to an embodiment of the present disclosure may not include the second optical amplifier 1231 in FIG. 6.

The pulse shaping signal MS may be input to the third optical fiber 1232. The third optical fiber 1232 may output the supercontinuum signal SC by expanding the bandwidth of the pulse shaping signal MS. For example, the third optical fiber 1232 may be a HNLF. The third optical fiber 1232 may expand the bandwidth of the pulse shaping signal MS through non-linear phenomena such as four wave mixing.

As described above, the OFC expansion unit 1200 according to an embodiment of the present disclosure may include the optical pulse adjusting device 1220, and the optical pulse adjusting device 1220 may be configured to include the second optical amplifier 1226. In other words, the second optical amplifier 1226 included in the OFC expansion unit 1200 according to an embodiment of the present disclosure may be placed in the optical pulse adjusting device 1220. Accordingly, unlike the case of FIG. 5, the supercontinuum generating device 1000 according to an embodiment of the present disclosure may adjust the flatness of the supercontinuum signal SC by comparing the optical spectrum shape of the optical amplification signal OAS amplified by the second optical amplifier 1226 with a target optical spectrum shape.

As a result, according to an embodiment of the present disclosure, in an optical amplification process by the second optical amplifier 1226, the supercontinuum generating device 1000 may adjust the amplification signal AO in consideration of distortion factors input to the spectrum adjustment signal SM. That is, according to an embodiment of the present disclosure, the supercontinuum generating device 1000 may not amplify the pulse shaping signal MS, thereby generating the supercontinuum signal SC with improved flatness characteristics.

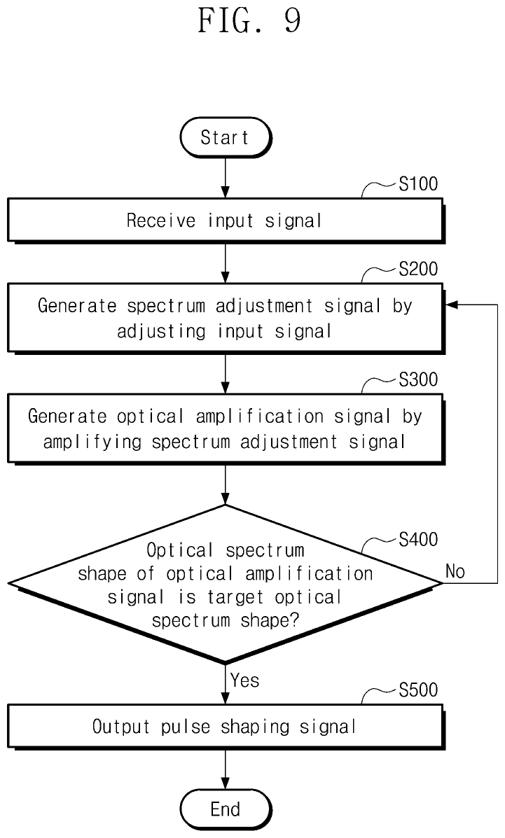

FIG. 9 is a flowchart illustrating an operating method of an optical pulse adjusting device, according to an embodiment of the present disclosure. FIG. 9 is described with reference to FIGS. 1 to 3, 4, and 7 to 8.

In operation S100, the optical pulse adjusting device 1220 may receive an input signal. For example, the input signal may be a signal based on the OFC signal OCS. For example, the input signal may be the amplification signal AO generated by the first non-linear stage 1210 of FIG. 3.

In operation S200, the optical pulse adjusting device 1220 may generate the spectrum adjustment signal SM by adjusting the input signal. For example, the input signal may be the amplification signal AO of FIG. 3. For example, the optical pulse adjusting device 1220 may generate the spectrum adjustment signal SM by adjusting an optical loss for each of wavelength components of the amplification signal AO.

In operation S300, the optical pulse adjusting device 1220 may generate the optical amplification signal OAS by amplifying the spectrum adjustment signal SM.

In operation S400, the optical pulse adjusting device 1220 may compare the optical spectrum shape of the optical amplification signal OAS with a target optical spectrum shape. In an embodiment, the target optical spectrum shape may be a Gaussian distribution shape. When the optical spectrum shape of the optical amplification signal OAS is the same as the target optical spectrum shape, the optical pulse adjusting device 1220 may output the pulse shaping signal MS to the outside (S500). In this case, the pulse shaping signal MS may be the optical amplification signal OAS. In the meantime, when the optical spectrum shape of the optical amplification signal OAS is not the same as the optical spectrum shape of the target optical signal, the optical pulse adjusting device 1220 may return to the operation of generating the spectrum adjustment signal (S200).

The above description refers to embodiments for implementing the present disclosure. Embodiments in which a design is changed simply or which are easily changed may be included in the present disclosure as well as an embodiment described above. In addition, technologies that are easily changed and implemented by using the above embodiments may be included in the present disclosure. While the present disclosure has been described with reference to embodiments thereof, it will be apparent to those of ordinary skill in the art that various changes and modifications may be made thereto without departing from the spirit and scope of the present disclosure as set forth in the following claims.

According to an embodiment of the present disclosure, a supercontinuum signal may be generated by adjusting an optical spectrum of an OFC signal amplified by an optical amplifier. Accordingly, the optical spectrum of the OFC signal may be adjusted in consideration of distortion factors added during an optical amplification process. As a result, a supercontinuum generating device that generates a supercontinuum signal with improved flatness may be provided.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. An optical pulse adjusting device comprising:
a pulse shaper configured to receive an input signal generated based on an optical frequency comb (OFC) signal and to output a spectrum adjustment signal by adjusting an optical spectrum shape of the input signal;
an optical amplifier configured to output an optical amplification signal by amplifying the spectrum adjustment signal;
an optical spectrum analyzer (OSA) configured to output an information signal by comparing an optical spectrum shape of the optical amplification signal with a target optical spectrum shape; and
a control circuit configured to output a comparison signal based on the information signal, and
wherein the pulse shaper is configured to:
further receive the comparison signal; and
adjust the optical spectrum shape of the input signal based on information about a difference between the optical spectrum shape of the optical amplification signal and the target optical spectrum shape, which is included in the comparison signal.

2. The optical pulse adjusting device of claim 1, wherein the pulse shaper is configured to:
adjust the optical spectrum shape of the input signal by adjusting an optical loss for each of wavelength components of the input signal based on the comparison signal.

3. The optical pulse adjusting device of claim 2, further comprising:
an optical coupler configured to branch the optical amplification signal and to input the branched optical amplification signal to the OSA.

4. The optical pulse adjusting device of claim 3, wherein the target optical spectrum shape is a Gaussian distribution shape.

5. The optical pulse adjusting device of claim 4, wherein the OFC signal is a signal generated based on an electro-optic (EO) modulation method.

6. The optical pulse adjusting device of claim 5, wherein the optical amplifier is a high power amplifier (HPA).

7. A supercontinuum signal generating device comprising:
an OFC signal generating unit configured to output an OFC signal; and
an OFC expansion unit configured to generate a supercontinuum signal by adjusting flatness of the OFC signal,
wherein the OFC expansion unit includes:
a first non-linear stage including a first optical amplifier and configured to output an amplification signal based on the OFC signal;
an optical pulse adjusting device configured to output a pulse shaping signal based on the amplification signal; and
a second non-linear stage configured to generate the supercontinuum signal based on the pulse shaping signal,
wherein the optical pulse adjusting device includes:
a pulse shaper configured to output a spectrum adjustment signal by adjusting an optical spectrum shape of the amplification signal;
a second optical amplifier configured to output an optical amplification signal by amplifying the spectrum adjustment signal;
an OSA configured to output an information signal by comparing the optical spectrum shape of the optical amplification signal with a target optical spectrum shape; and
a comparison device configured to output a comparison signal based on the information signal,
wherein the pulse shaper is configured to:
adjust the optical spectrum shape of the amplification signal based on information about a difference between the optical spectrum shape of the optical amplification signal and the target optical spectrum shape, which is included in the comparison signal, and
wherein the pulse shaping signal is the optical amplification signal when the optical spectrum shape of the optical amplification signal is the target optical spectrum shape.

8. The supercontinuum signal generating device of claim 7, wherein the pulse shaper is configured to:
adjust the optical spectrum shape of the amplification signal by adjusting an optical loss for each of wavelength components of the amplification signal based on the comparison signal.

9. The supercontinuum signal generating device of claim 8, wherein the target optical spectrum shape is a Gaussian distribution shape.

10. The supercontinuum signal generating device of claim 9, wherein the OFC signal generating unit is configured to:
generate the OFC signal in an EO modulation method.

11. The supercontinuum signal generating device of claim 9, wherein the OFC signal generating unit is configured to:
generate the OFC signal based on a resonator.

12. The supercontinuum signal generating device of claim 10, wherein the optical pulse adjusting device further includes:
an optical coupler configured to branch the optical amplification signal and to input the branched optical amplification signal to the OSA.

13. The supercontinuum signal generating device of claim 12, wherein the first non-linear stage further includes:
a first optical fiber connected to an output terminal of the first optical amplifier; and
a second optical fiber connected to the first optical fiber,
wherein the first optical amplifier, the first optical fiber, and the second optical fiber are configured to generate the amplification signal by expanding a bandwidth of the OFC signal.

14. The supercontinuum signal generating device of claim 13, wherein the second non-linear stage includes a third optical fiber, and
wherein the third optical fiber is configured to generate the supercontinuum signal by expanding a bandwidth of the pulse shaping signal.

15. The supercontinuum signal generating device of claim 14, wherein the first optical fiber is a single mode fiber (SMF).

16. The supercontinuum signal generating device of claim 15, wherein each of the second optical fiber and the third optical fiber a highly non-linear fiber (HNLF).

17. The supercontinuum signal generating device of claim 16, wherein the first optical amplifier is an erbium-doped fiber amplifier (EDFA), and the second optical amplifier is a high power amplifier (HPA).

18. An operating method of an optical pulse adjusting device outputting a pulse shaping signal, the method comprising:
receiving an input signal generated based on a frequency comb signal;
generating a spectrum adjustment signal by adjusting an optical loss for each of wavelength components of the input signal;
amplifying the spectrum adjustment signal and generating an optical amplification signal by expanding a bandwidth of the spectrum adjustment signal;
comparing an optical spectrum shape of the optical amplification signal with a target optical spectrum shape; and
outputting the pulse shaping signal based on the comparison result.

19. The method of claim 18, wherein the outputting of the pulse shaping signal further includes:
outputting the optical amplification signal as the pulse adjustment signal, when the optical spectrum shape of the optical amplification signal is the same as the target optical spectrum shape.

20. The method of claim 18, wherein the target optical spectrum shape is a Gaussian distribution shape.
